(19) United States
(12) Patent Application Publication
(10) Pub. No.: US 2009/0304860 A1
(43) Pub. Date: Dec. 10, 2009

(54) Enzymatic Replacement of Emulsifiers on the Basis of Monoglycerides

(75) Inventors: Norman Burkardt, Dreieich (DE); Oscar Diez Poza, Pfungstadt (DE); Markus Schmitt, Weinheim (DE); Charles Sutcliffe, Northhamptonshire (GB)

Correspondence Address: EDWARDS ANGELL PALMER & DODGE LLP, P.O. BOX 55874, BOSTON, MA, 02205, US

(73) Assignee: AB Enzymes Gmbh, Darmstadt (DE)

(21) Appl. No.: 12/083,908

(22) PCT Filed: Oct. 19, 2006
(86) PCT No.: PCT/EP2006/010116

§ 371 Date: Jul. 28, 2008

(30) Foreign Application Priority Data
Oct. 20, 2005 (DE) 10 2005 050 332.2

(51) Int. Cl. A21D 8/04; A21D 2/26; A21D 15/00

(52) U.S. Cl. 426/18; 426/61

(57) ABSTRACT

The present invention relates to the use of an α-amylase obtainable from Thermoactinomyces vulgaris for the production of dough and/or bakery products in which emulsifiers on the basis of monoglycerides are partially or fully dispensed with, and to a method for the production of bakery products comprising no or small amounts of emulsifiers on the basis of monoglycerides characterized in that i) a dough for the respective bakery product is produced in a way known per se, using no or small amounts of emulsifiers on the basis of monoglycerides, ii) an α-amylase obtainable from Thermoactinomyces vulgaris is added to the dough or a component of the dough, and iii) the dough is processed in a way known per se to ready-to-eat bakery products.

The present invention relates to a method for the production of bakery products containing no or small amounts of emulsifiers on the basis of monoglycerides. The present invention also relates to the use of α-amylase obtainable from Thermoactinomyces vulgaris for the production of dough and/or bakery products in which emulsifiers on the basis of monoglycerides are partially or fully dispensed with.

Emulsifiers are very often used in practical baking applications and serve, e.g., to improve the dough rheology, to increase the volume of pastries, to improve the beating volume (“Aufschlagvolumen”) and the foam stability of masses etc. Depending on the field of application, different types of emulsifiers are used. Emulsifiers on the basis of monoglycerides are mainly used for toasted pastries and sandwich pastries and for sweet bakery products/pastries (for example, sweet yeast doughs and chemically leavened cake-like pastries) and serve to improve the texture of the crumb (softness, sensoric features). An increase in the softness of the crumb, a more juicy crumb (sensoric evaluation) as well as a “shorter bite” (“kürzerer Biss”) of the crumb are characteristic therefor. Monoglycerides are also associated with a clear decrease in the elasticity of the crumb and the resililence of the crumb, respectively, which gives some types of pastries their characteristic crumb consistency (Handbuch Backmittel und Grundstoffe, Backmittelinstitut e.V., Behr's Verlag, 1st edition, 1999). Examples of monoglyceride emulsifiers are monoglycerides and diglycerides, glyceryl monostearate and distilled monoglycerides. Emulsifiers on the basis of monoglycerides are, however, not tolerated by all people and often also rejected, respectively. Such compounds may, thus, result in allergies or incompatibility reactions. In the field of organic bakery products emulsifiers are generally regarded as critical and are widely rejected. Another disadvantage is that the monoglyceride emulsifiers tend to clump if they are improperly stored, e.g. at increased temperatures, which impairs the processability.

Therefore, there is a need for methods for the production of bakery products that are free or essentially free of emulsifiers on the basis of monoglycerides. By means of the method according to the present invention the bakery products shall be given the desired effects of the monoglycerides, i.e. softness of the crumb as well as adequate texture of the crumb, however, without negatively influencing the other characteristics, such as, in particular, the taste and the aroma of the bakery products. The method according to the present invention shall be easily applicable and applicable in small bakeries as well as in large bakeries. The method according to the present invention shall be inexpensive and suitable for combined applications as well as for different technologies for the production of bakery products.

Surprisingly, it has been found that it is possible to partially or fully dispense with emulsifiers on the basis of monoglycerides by using an α-amylase obtainable from Thermoactinomyces vulgaris in bakery products. It was particularly found that the use of this amylase perfectly substitutes the effect of monoglycerides in view of softness of the crumb and texture of the crumb and also provides the bakery products with further positive characteristics. The use of the α-amylase obtainable from Thermoactinomyces vulgaris is also cheaper than the use of emulsifiers on a monoglyceride basis. Moreover, this use does not have to be declared in the form of an E number, since enzymes do not represent an additive but a processing adjuvant. The use of the α-amylase from Thermoactinomyces vulgaris is also suitable for numerous baking technologies.

Therefore, the present invention relates to the use of an α-amylase obtainable from Thermoactinomyces vulgaris for the production of dough and/or bakery products in which emulsifiers on the basis of monoglycerides are partially or fully dispensed with. The present invention also relates to a method for the production of bakery products containing no or small amounts of emulsifiers on the basis of monoglycerides characterized in that i) a dough for the respective bakery product is produced in a way known per se, using no or small amounts of emulsifiers on the basis of monoglycerides, ii) an α-amylase obtainable from Thermoactinomyces vulgaris is added to the dough or a component of the dough, and iii) the dough is processed in a way known per se to ready-to-eat bakery products.

The present invention also relates to the bakery products obtained by this method as well as semi-finished products and finished products for the production of respective bakery products.

So far various fats have been used to substitute monoglycerides. To some extent they act like monoglycerides; however, compared to monoglycerides, they mostly do not have such a distinctive effect on the softness of the crumb and the texture of the crumb. In particular, fats with a high portion of unsaturated fatty acids, such as certain margarines, or animal lard were used here. It is obvious that these fats are not suitable for all types of bakery products and baking technologies.

The specific replacement of monoglycerides by enzymes in bakery products has not been described yet. The use of α-amylase to prevent staling of bakery products is disclosed. The publication Cereal Foods World, volume 42, No. 10, page 802 et seq., October 1997, discloses the use of bacterial maltogenic α-amylase, bacterial thermostable α-amylase and fungal α-amylase to prevent staling of bakery products. The comparison of the effects of these enzymes shows, however, serious differences to the effect that is achieved by adding monoglycerides to the dough. While the fungal α-amylase has a just about comparable effect on the softness of the crumb, it has no influence on the elasticity of the crumb and the starch retrogradation. The bacterial, thermostable α-amylase has a comparatively advantageous effect on the softness of the crumb; however, it reduces the elasticity of the crumb due to the high thermostability. The bacterial maltogenic α-amylase has an effect comparable to monoglycerides regarding the softness of the crumb, while the elasticity of the crumb is too high compared to monoglycerides and is, thus, disadvantageously influenced. It can, therefore, be deduced from this publication that not only fungal but also bacterial α-amylase is widely unsuitable to replace monoglycerides. In the publication Food Tech Europe, page 66 et seq., March/April 1996, the use of a maltogenic exo-amylase to prevent staling of bakery products is described, wherein a very elastic crumb is obtained, making this amylase unsuitable to replace monoglycerides in bakery products. Moreover, it is referred to the heat stability of the bacterial thermostable α-amylase, resuiting in a rubber-like, sticky structure of the crumb, making this amylase also unsuitable to replace monoglycerides in bakery products. It is also pointed out that the fungal α-amylase does not influence the elasticity of the crumb.

EP 0 942 654 describes a method for the production of stay-fresh bakery products by using an α-amylase deriving from Thermoactinomyces vulgaris. In this case it is specifically focused on the characteristics of the bakery products after a longer storage time. This publication does not include any reference to the effect that emulsifiers or even the specific class of monoglyceride emulsifiers may be replaced by this α-amylase.

Therefore, it was surprising that an α-amylase obtainable from Thermoactinomyces vulgaris is ideally suitable to replace emulsifiers on the basis of monoglycerides in bakery products. Regarding softness of the crumb and elasticity of the crumb as well as humidity feel and mouthfeel, the α-amylase from Thermoactinomyces vulgaris corresponds to the effects of monoglyceride emulsifiers. It was not possible to achieve such an effect with other α-amylases.

The α-amylase obtainable from Thermoactinomyces vulgaris is described in DD 288 395. It describes its production by fermenation of Thermoactinomyces vulgaris and its use for the cleavage of starch under the formation of hydrolysates being rich of maltose and maltotriose. The enzyme has an isoelectrical point of pI 5.57, a pH optimum between pH 4 and pH 8 and a relatively low thermostability. After twenty minutes of thermal stress of the enzyme in aqueous solution at 40° C. activity is, thus, no longer found. The cleavage pattern of the α-amylase from Thermoactinomyces vulgaris is characteristic: Soluble products consisting of 4.3% glucose, 54.4% maltose, 20.5% maltotriose and soluble starch fragments as the balance are obtained in the hydrolysis of native wheat starch (cf. DD 287 732). Therefore, one feature of the α-amylase used according to the present invention is a content of 50-60% by weight of maltose in the soluble cleavage products in the hydrolysis of wheat starch.

The enzyme produced according to the production method of culturing Thermoactinomyces vulgaris as described in the above DD patents may directly be used for the purposes of the present invention. However, Thermoactinomyces vulgaris is no particularly productive strain for producing the α-amylase. Thus, it has already been successfully tried to produce this enzyme by means of recombinant micro-organisms. For example, the isolation of the α-amylase gene from Thermoactinomyces vulgaris as well as the expression of this gene in Escherichia coli and Bacillus subtilis are described in Appl. Environ. Microbiol. (1994, 60(9), pages 3381-3389). Bacillus strains and particularly Bacillus subtilis are especially effective host organisms. The α-amylase gene from Thermoactinomyces vulgaris was introduced in a host organism by means of a gen construct with a B. subtilis plasmid as vector. This will then be grown in an appropriate nutrient medium on the basis of C sources and N sources and inorganic salts. Since the enzyme yield is clearly better in the production via recombinant micro-organisms, an enzyme produced in such a way is preferred for the use according to the present invention. Of course, it is also possible to use an enzyme produced in a conventional way.

According to the present invention, the α-amylase may be used as monopreparation or also in combination with other baking enzymes, such as further amylases, glucosidases, glucoamylases, proteinases, lipases, phospholipases, lipoxygenases, cellulases, hemicellulases (pentosanases, xylanases), pullulanases, oxidases or transglutaminases. In a combined preparation it is preferred to use a maltogenic α-amylase as a further baking enzyme besides the α-amylase from Thermoactinomyces vulgaris. Further preferred combinations are combinations of the α-amylase from Thermoactinomyces vulgaris with hemicellulases (pentosanases, xylanases) and/or glucoamylases. Particularly preferred is a combination of the α-amylase from Thermoactinomyces vulgaris, a maltogenic α-amylase and hemicellulases (pentosanases, xylanases).

It is also possible to use sequence variations of the α-amylase obtainable from Thermoactinomyces vulgaris and α-amylases from other organisms corresponding to this α-amylase, respectively, as long as they do not significantly differ from the characteristics of the α-amylase obtainable from Thermoactinomyces vulgaris in view of their effect on the softness of the crumb and the elasticity of the crumb.

According to the present invention, monoglycerides in bakery products may be completely or partly replaced by the α-amylase obtainable from Thermoactinomyces vulgaris. In particular, the following emulsifiers on a monoglyceride basis are replaced by the α-amylase from Thermoactinomyces vulgaris: monoglycerides and diglycerides, glyceryl monostearate and distilled monoglycerides. According to the present invention, emulsifiers on a monogylceride basis may be completely replaced by the α-amylase from Thermoactinomyces vulgaris used according to the present invention. However, it is also possible to replace only a part of the monoglyceride-based emulsifiers. Exemplary for this are combinations of monoglyceride emulsifiers and α-amylase.

Bakery products that are essentially free of emulsifiers on a monoglyceride basis are bakery products without any addition of monoglyceride emulsifiers or bakery products containing technologically ineffective amounts of them, which may have, for example, got into the bakery products by further baking ingredients. Bakery products containing small amounts of emulsifiers on a monoglyceride basis are bakery products with a content of up to 0.3% (w/w) monoglyceride emulsifier based on of the content of flour.

The use according to the present invention is suitable for all baking applications in which monoglyceride emulsifiers are used. Preferably, these are tin white loaves (“Kastenweiβbrote”), bread for toasting and pastries. These bakery products may also be produced by any flour, for example, wheat flour, oat flour, rye flour, dinkel flour or special flours, such as rice flour, potato flour, soy flour or combinations thereof.

The enzyme alone or in combination with other enzymes may already be added to the flour that is used for the production of the bakery products. It may, however, be also included in one of the ingredients of the dough or in a baking aid that is added to the flour or the dough. Preferably, it is directly admixed with the dough. The enzyme may also be admixed with a predough optionally used. It is essential that the enzyme is contained in the dough when the baking process starts, i.e. before the dough and the dough pieces, respectively, are transferred by heating into solid, non-perishable, aromatic bakery products. The use according to the present invention is particularly suitable for bakery products that are produced by adding yeast and/or baking powder. However, it is also suitable for bakery products that are produced by means of sourdough, such as wheat mixed bread.

The enzyme is added in a dosage of 250-25,000 AZ per 100 kg flour, preferably 500-18,000 AZ per 100 kg flour, more preferred 1,000-12,000 AZ per 100 kg flour. The enzyme unit is indicated in AZ units and is determined as follows:

Measuring principle of the determination of AZ: The reducing sugars released by the enzymatic cleavage of the starch are reacted with p-hydroxybenzoic acid hydrazide (PAHBAH) to bisphenol hydrazone anions, which are photometrically measured at 412 nm.

Buffer Solution

1 M sodium acetate solution (136 g sodium acetate trihydrate in 1,000 ml demineralised water) is adjusted with 1 M acetic acid (60 g conc. acetic acid in 1,000 ml deionised water (“VE” water)) at pH 5.0. This solution is diluted with demineralised water to 0.04 M for the production of the substrate solution. For preparing the substrate solution, fresh 0.15 g soluble starch are slurried in about 70 ml 0.04 M buffer, pH 5.0, every day. This mixture is gelatinated in a boiling water bath for 2 min under constant swaying. Subsequently, the solution is kept in the boiling water for further 5 min. After cooling it down in cold water to room temperature, the substrate solution is filled up with buffer to 100 ml.

The PAHBH reagent solution (0.5%) is prepared from a 5% stock solution. 25 g p-hydroxybenzoic acid hydrazide (PAHBAH) are dissolved in 500 ml 0.5 M HCl (in Milli-Q-H₂O). The stock solution is stored in a refrigerator. For dilution 50 ml, cold, are given to a solution of 2.325 g Titriplex III dissolved in about 200 ml 0.5 M NaOH (in Milli-Q-H₂O) and filled up with 0.5 M NaOH to 500 ml. The solution is not stable in the alkaline range and, therefore, it must be prepared freshly every day.

The enzyme dilutions are prepared with tap water. The dilution is to be selected in such a way that the extinction difference between the main value and the blind value is between 0.3 and 0.5 absorption units (AU).

For calibrating the method, a glucose solution (0.018 g in 100 ml in 0.04 M Na-acetate buffer pH 4.5) is used.

Determination of the Molar Extinction Co-Efficient

Main value: 500 μl buffer are mixed with 1,300 μl hydrazide solution and 200 μl glucose standard solution.

Blind value: 700 μl buffer are mixed with 1,300 μl hydrazide solution.

After a colour development of 30 min at 75° C., the main value and blind value are measured at 412 nm. The molar extinction co-efficient is measured with the determined extinction difference. To determine the molar distinction co-efficient, 32 determinations were carried out, and on their basis the mean value of ε=0.001098 l*μmol⁻¹*mm⁻¹ was determined as the constant and used in the calculation. The enzyme samples are determined in sealable reaction vessels.

Measurement of Enzyme Samples

Main value: 500 μl substrate are pre-tempered for 5 min at 30° C. 200 μl enzyme solution are added by means of a pipette and well mixed. After 20 min of incubation time the reaction is stopped with 1,300 μl hydrazide reagent. After a colour development of 30 min at 75° C., the samples are cooled down in an ice bath for about 5 min and photometrically measured at 412 nm. The absolute extinction of the main value may not exceed 1.8 AU.

Blind value: 500 μl substrate are pre-tempered for 5 min at 30° C. and mixed with 1,300 μl hydrazide reagent. Subsequently, 200 μl enzyme solution are added by means of a pipette. The solution is mixed and in the following further treated like the main value. The measurement is evaluated as follows:

Calculation of the Molar Extinction Co-Efficient

$$ɛ = \frac{{E}_{Glucose}}{c * d} \qquad ( 1 )$$

Calculation of the Activity

$$AZH / g = \frac{Δ E * V}{ɛ * d * v * t * {c}_{s}} \qquad ( 2 )$$

The fixed parameters may be combined to a constant.

$${K}_{1} = \frac{V}{ɛ * d * v * t} = 45.54 \qquad ( 3 )$$

Final Formula for Calculating AZH

$$AZH * {g}^{- 1} = \frac{Δ {E}_{412}}{{c}_{s}} * {K}_{1} \qquad ( 4 )$$

To convert the thus obtained indications of activity to the unit of AZ, the result is multiplied with a constant.

$$\frac{AZ}{g} = \frac{AZH}{g} \times \frac{1}{44} \qquad ( 5 )$$

It is not necessary to change the usual recipes for the bakery products if α-amylase from Thermoactinomyces vulgaris is used instead of monoglyceride emulsifiers, i.e. the previous recipes for the respective bakery products may be used provided that α-amylase from Thermoactinomyces vulgaris in the above indicated dosage is used instead of the monoglycerides. The necessary dosage can be easily determined by a person skilled in the art by means of the usual baking experiments. The α-amylase from Thermoactinomyces vulgaris used according to the present invention may be advantageously combined with the adjuvants and additives that are usual in baking, such as hydrocolloids, additives, agents for acidifying the dough, baking agents etc.

The bakery products obtained according to the present invention do not differ from the respective usual bakery products produced by means of monoglycerides in view of softness of the crumb and resilience of the crumb. Moreover, these bakery products also have the advantageous effect, caused by the monoglycerides, that they have a very appealing humidity feel and mouthfeel. According to the present invention, the bakery products are produced in a way known per se according to the usual technological methods, using α-amylase from Thermoactinomyces vulgaris instead of emulsifiers on a monoglyceride basis. The method is very safe, since the bread fault of a sticky, humid crumb, which is known from the thermostable bacterial α-amylase, does not even occur if there is a multiple overdosage. The enzyme according to the present invention is completely deactivated after the baking process. Its activity is no longer detectable in the finished bakery products.

According to the present invention, fresh bakery products are preferably produced. However, it is also possible to prepare finished products or semi-finished products, such as raw proofed or unproofed dough pieces or prebaked dough pieces, which are sold uncooled, cooled, quick-frozen or deep-frozen and are finally baked by the end-consumers. The invention also relates to baking mixtures for the production of bakery products obtainable according to the present invention. These baking mixtures contain, for example, cereal flours and/or non-cereal flours, hydrocolloids, oxidation agents, emulsifiers, e.g. diacetyl tartaric acid esters, sodium stearyl lactylates or calcium stearyl lactylates, polyglycerol fatty acid esters etc., inorganic salts, e.g. phosphates, sulphates, carbonates etc., and enzymes, wherein different combinations are possible.

The intention is explained in more detail in the attached figures. It is shown in

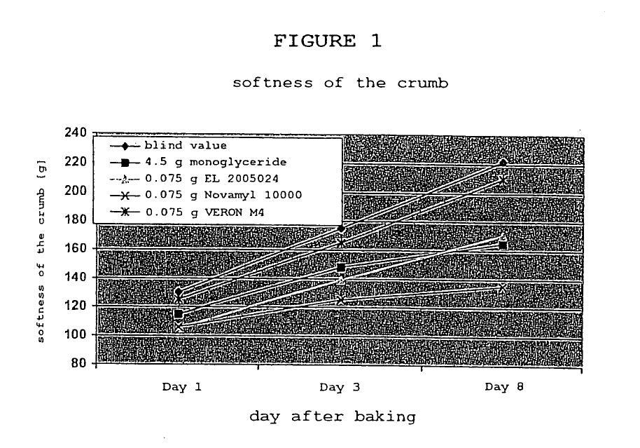

FIG. 1: The comparison of the effects of monoglyceride, α-amylase from Thermoactinomyces vulgaris (=EL 2005024), Nova-myl® 10000 BG and VERON® M4 on the softness of the crumb of wheat breads (English baking technology).

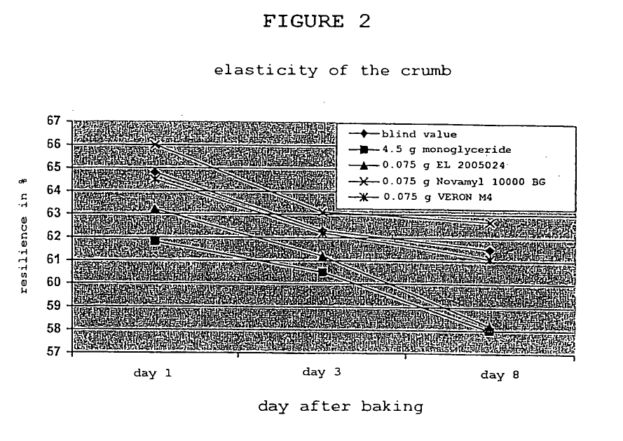

FIG. 2: The comparison of the effects of monoglyceride, α-amylase from Thermoactinomiyces vulgaris (=EL 2005024), Nova-myl® 10000 BG and VERON® M4 on the elasticity of the crumb of wheat breads (English baking technology).

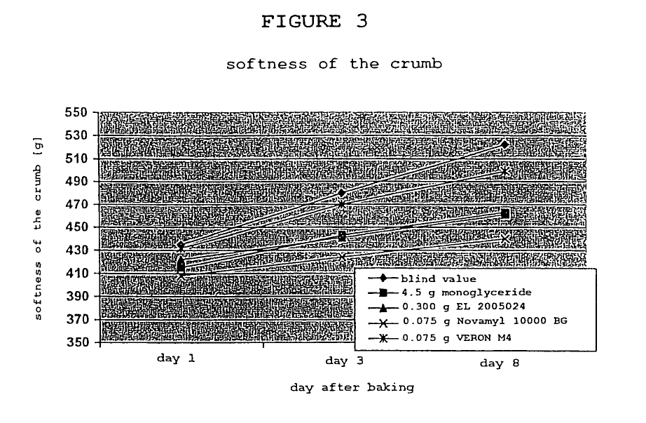

FIG. 3: The comparison of the effects of monoglyceride, α-amylase from Thermoactinomyces vulgaris (=EL 2005024), Nova-myl®10000 BG and VERON® M4 on the softness of the crumb of wheat breads (German baking technology).

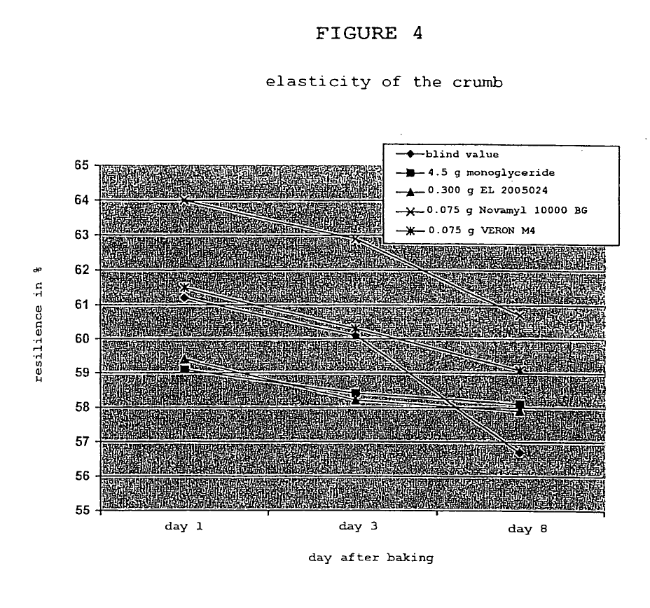

FIG. 4: The comparison of the effects of monoglyceride, α-amylase from Thermoactinomyces vulgaris (=EL 2005024), Nova-myl® 10000 BG and VERON® M4 on the elasticity of the crumb of wheat breads (German baking technology).

The invention will now be explained in more detail on the basis of the following examples.

### EXAMPLE 1

### Baking Experiment Regarding the Replacement of Monogylcerides by Various α-Amylases in Wheat Breads (English Baking Technology)

Carrying Out of the Baking Experiments:

A dough consisting of 1,500 g wheat flour (English flour-Kingsmill flour), 930 ml water, 45 g yeast, 30 g salt, 0.075 g ascorbic acid and 6 g calcium propionate and the additions of enzyme and monoglyceride, respectively, as indicated below, is produced in a Tweedy mixer. The energy input of the kneading is 12 watt-hours per kilogram dough, applying a vacuum with a delay of 30 seconds. The desired temperature of the dough is about 28° C. After a relaxation phase for the dough of 3 minutes, the dough is separated in 4 dough pieces of 600 g each and shaped. The fermentation time in a rectangular cake tin closed with a cap is 45 minutes at 40° C. and 70% air humidity. The baking time is 30 minutes at 240° C. top heat and 220° C. bottom heat. Directly after insertion into the oven, steam is injected for 5 seconds and after a break of 3 seconds there is a second steam injection of 5 seconds this time. The exhaust is opened after 2 minutes and closed again after further 28 minutes. It was baked in an oven, type “Infra AE 416/38, year of construction 10/2001” of the company Wachtel GmbH, Germany. When the loaves are cooled down, they are packed in plastic bags, sealed and stored at room temperature. On the first, the third and the eighth day after the baking, the softness as well as the elasticity and resilience, respectively, of the bread crumb is measured via a texture analyser, and EL 2005024 (=α-amylase from Thermoactinomyces vulgaris) is compared with monoglyceride. Ideally, both curves are congruent.

Description of the Measurement of the Softness of the Crumb and Resilience, Respectively, Via a Texture Analyser:

The texture analyser of the company Stable Micro Systems, TA.XT2, is used as a measuring tool. To prepare the samples, three slices of 25 mm thickness each are cut out of the middle of the baked bread with an electric bread knife, and via the texture analyser the softness of the crumb and the elasticity of each slice is measured individually. In the evaluation of the results the mean values of the respective measurements are used. The softness of the crumb is described by point P1, which is reached at a penetration speed of 1 mm/second of the stamp with a diameter of 50 mm after 6.25 mm. The result is indicated as gram. The elasticity is determined by the ratio of P3/P2×100%. The value P2 is obtained after 7 mm compression. P3 is the value that is obtained if the compression is kept for further 30 seconds after 7 mm penetration depth.

Experimental Design:

The baking experiments were carried out according to the method described above:
Test 1: blind value—without enzyme and addition of monoglyceride.
Test 2: with addition of 4.5 g (0.3%, on flour) monoglyceride Abimono 90V. Abimono 90V is a product of the company Abitec Ltd., United Kingdom, and contains at least 90% monoglycerides, maximal 1% free glycerol and hydrogenated palm oil with a melting point of about 65° C.
Test 3: with addition of 0.075 g (50 ppm, on flour) EL 2005024 (=α-amylase from Thermoactinomyces vulgaris) corresponding to an activity of at least 16.5 AZ. EL 2005024 is a test preparation of the company AB Enzymes GmbH, Germany, and contains at least 220 AZ/g bacterial α-amylase from Thermoactinomyces vulgaris.
Test 4: with addition of 0.075 g (50 ppm) Novamyl® 10000 BG (maltogenic α-amylase). Novamyl® 10000 BG is a product of the company Novozymes A/S, Denmark, and contains bacterial maltogenic α-amylase.
Test 5: with addition of 0.075 g (50 ppm) VERON® M4 (fungal α-amylase). VERON® M4 is a product of the company AB Enzymes GmbH, Germany, and contains at least 1,728 AZ/g fungal α-amylase.

The measurement of the softness of the crumb and the elasticity was also carried out by means of the texture analyser according to method described above.

Results

The results depicted in FIGS. 1 and 2 show clearly softer characteristics of the crumb for monoglyceride as well as for EL 2005024 compared to the blind value on the first, the third and the eight day. Monoglyceride and EL 2005024 are almost congruent, verifying the substitutability of monoglyceride by EL 2005024 in view of the softness of the crumb. The results regarding the elasticity of the crumb are also similar, and the possibility of a replacement is, thus, clearly expressed. It is not possible to obtain corresponding curves with maltogenic amylase (Novamyl® 10000 BG) and fungal amylase (VERON® M4), respectively.

### EXAMPLE 2

### Baking Experiment Regarding the Replacement of Monoglyceride by Various α-Amylases in Wheat Breads (German Baking Technology)

Carrying Out of the Baking Experiments:

A dough consisting of 1,500 g wheat flour, 870 ml water, 45 g yeast, 30 g salt, 0.075 ascorbic acid and 6 g calcium propionate is prepared in a Diosna (type SP12) spiral kneader. The kneading time is 2 minutes at stage 1 and, subsequently, further 6 minutes at stage 2. The enzymes are each added in liquid form with the water poured in. The desired temperature of the dough is 26° C. After a relaxation phase of the dough of 10 minutes, the dough is separated in 4 dough pieces of 600 g each and shaped to round pieces (“rundgewirkt”). After further 20 minutes of dough relaxation, the pieces are elongated (“Langwirken”) and filled into the rectangular cake tin, which is closed by a cap. The fermentation of 80 minutes takes place in a fermentation cabinet at 32° C. and 80% air humidity, the subsequent baking at 230° C. for about 40 minutes.

Directly after the insertion into the oven, steam is injected for 5 seconds and after a break of 3 seconds, there is a second steam injection of 5 seconds this time. The exhaust is opened after 2 minutes and closed again after further 28 minutes. It was baked in a oven type “Infra AE 416/38, year of construction 10/2001” of the company Wachter GmbH, Germany.

When the loaves are cooled down, they are packed in plastic bags, sealed and stored at room temperature. On the first, the third and the eight day after the baking the softness and the resilience of the bread crumb is measured via a texture analyser, and EL 2005024 is compared to monoglyceride. Ideally, both curves are congruent. The softness of the crumb and the resilience, respectively, is measured via a texture analyser as described in Example 1. The experimental designs are also in accordance with the experimental designs depicted in Example 1.

Results

The results depicted in FIGS. 3 and 4 show clearly softer characteristics of the crumb for monoglyceride as well as for EL 2005024 compared to the blind value on the first, the third and the eight day. Monoglyceride and EL 2005024 are almost congruent, making monoglyceride replaceable by EL 2005024 to the full extent. The results regarding the resilience are also similar, and the possibility of a replacement is, thus, clearly expressed. Compared to the baking experiments with the English baking technology, higher enzyme dosage were necessary for the German baking technology to cause such an effect.

### EXAMPLE 3

### Sensoric Evaluation of the Bakery Products

The bakery products obtained in Examples 1 and 2 were each sensorically reviewed by a test panel after the first, the third and the eight day after production. The parameters of softness, elasticity and chewing impression were evaluated.

The following parameters were examined under the following criteria:
Softness: slightly soft, soft, slightly firm, firm;
Elasticity: normal, elastic, slightly inelastic, inelastic;
Chewing impression: normal, slightly dry, dry, slightly humid, humid, crumbly.

The results are depicted in the following Table 1:

TABLE 1
A) English Baking Technology after Day 1:

| | | | | | |
|---|---|---|---|---|---|
| sensoric | blind | 4.5 g mono | 0.075 g | 0.075 g | 0.075 g |
| parameters: | value | glyceride | EL 2005024 | Novamyl | VERON M4 |
| | | | | 10000 | |
| softness | slightly | soft | soft | soft | slightly |
| | firm | | | | firm |
| elasticity | normal | slightly | slightly | elastic | normal |
| | | inelastic | inelastic | | |
| chewing | normal | slightly humid | slightly | slightly | normal |
| impression | | | humid | humid | |

German Baking Technology after Day 1:

| | | | | | |
|---|---|---|---|---|---|
| sensoric | blind | 4.5 g mono- | 0.300 g | 0.075 g | 0.075 g |
| parameters: | value | glyceride | EL 2005024 | Novamyl | VERON M4 |
| | | | | 10000 | |
| softness | slightly | soft | soft | soft | slightly |
| | firm | | | | firm |
| elasticity | normal | slightly inelastic | slightly | elastic | normal |
| | | | inelastic | | |
| chewing | normal | slightly humid | slightly | slightly | normal |
| impression | | | humid | humid | |

B) English Baking Technology after Day 3:

| | | | | | |
|---|---|---|---|---|---|
| sensoric | blind | 4.5 g mono- | 0.075 g | 0.075 g | 0.075 g |
| parameters: | value | glyceride | EL 2005024 | Novamyl | VERON M4 |
| | | | | 10000 | |
| softness | slightly | soft | soft | soft | slightly |
| | firm | | | | firm |
| elasticity | normal | slightly | slightly | elastic | normal |
| | | inelastic | inelastic | | |
| chewing | normal | slightly | slightly | normal | normal |
| impression | | humid | humid | | |

German Baking Technology after Day 3:

| | | | | | |
|---|---|---|---|---|---|
| sensoric | blind | 4.5 g mono- | 0.075 g | 0.075 g | 0.075 g |
| parameters: | value | glyceride | EL 2005024 | Novamyl | VERON M4 |
| | | | | 10000 | |
| softness | slightly | soft | soft | soft | slightly |
| | firm | | | | firm |
| elasticity | normal | slightly | slightly | elastic | normal |
| | | inelastic | inelastic | | |
| chewing | normal | slightly | slightly | normal | normal |
| impression | | humid | humid | | |

C) English Baking Technology after Day 8:

| | | | | | |
|---|---|---|---|---|---|
| sensoric | blind | 4.5 g mono | 0.075 g | 0.075 g | 0.075 g |
| parameters: | value | glyceride | EL 2005024 | Novamyl | VERON M4 |
| | | | | 10000 | |
| softness | slightly | slightly | slightly | soft | slightly |
| | firm | soft | soft | | firm |
| elasticity | inelastic | slightly | slightly | elastic | normal |
| | | inelastic | inelastic | | |
| chewing | crumpy | slightly | slightly humid | normal | slightly |
| impression | | humid | | | crumpy |

German Baking Technology after Day 8:

| | | | | | |
|---|---|---|---|---|---|
| sensoric | blind | 4.5 g mono- | 0.075 g | 0.075 g | 0.075 g |
| parameters: | value | glyceride | EL 2005024 | Novamyl | VERON M4 |
| | | | | 10000 | |
| softness | slightly | slightly | slightly | soft | slightly |
| | firm | soft | soft | | firm |
| elasticity | inelastic | slightly | slightly | elastic | normal |
| | | inelastic | inelastic | | |
| chewing | crumpy | slightly | slightly | slightly dry | slightly |
| impression | | humid | humid | | crumpy |

The results show that identical results are obtained in the bakery products when using monoglycerides and when using EL 2005024, i.e. it is not possible to differentiate between the bakery products in view of their sensoric and rheologic impression. Thus, this test also verifies that monoglyceride is completely replaceable by α-amylase from Thermoactinomyces vulgaris.

1. Use of an α-amylase obtainable from Thermoactinomyces vulgaris for the production of dough and/or bakery products in which emulsifiers on the basis of monoglycerides are partially or fully dispensed with.

2. The use according to claim 1 characterized in that the α-amylase is an α-amylase produced via gene technology using the gene of the α-amylase from Thermoactinomyces vulgaris in a host organism.

3. The use according to claim 2 characterized in that the host organism is a Bacillus strain.

4. The use according to claim 3 characterized in that the host organism is a Bacillus subtilis strain.

5. The use according to claim 1 characterized in that 250-25,000 AZ, preferably 500-18,000 AZ, more preferred 1,000-12,000 AZ activity units of the enzyme based on 100 kg flour are added to the dough.

6. The use according to claim 1 characterized in that one or more baking enzyme(s) selected from amylases, glucosidases, glucoamylases, proteinases, lipases, phospholipases, lipoxygenases, cellulases, hemicellulases (pentosanases, xylanases), pullulanases, oxidases or transglutaminases is/are additionally added to the dough.

7. The use according to claim 6 characterized in that the further amylase is a maltogenic α-amylase.

8. A method for the production of bakery products containing no or small amounts of emulsifiers on the basis of monoglycerides characterized in that
a dough for the respective bakery product is produced in a way known per se, using no or small amounts of emulsifiers on the basis of monoglycerides,
an α-amylase obtainable from Thermoactinomyces vulgaris is added to the dough or a component of the dough, and
the dough is processed in a way known per se to ready-to-eat bakery products.

9. The method according to claim 8 characterized in that an α-amylase produced genetically by means of the gene of the α-amylase of Thermoactinomyces vulgaris in a host organism is used.

10. The method according to claim 9 characterized in that the host organism is a Bacillus strain.

11. The method according to claim 10 characterized in that the host organism is a Bacillus subtilis strain.

12. The method according to claim 8 characterized in that 250-25,000 AZ, preferably 500-18,000 AZ, more preferred 1,000 to 12,000 AZ activity units based on 100 kg flour are added to the dough.

13. The method according to claim 8 characterized in that one or more baking enzyme(s) selected from amylases, glucosidases, glucoamylases, proteinases, lipases, phospholipases, lipoxygenases, cellulases, hemicellulases (pentosanases, xylanases), pullulanases, oxidases or transglutaminases is/are added to the dough.

14. The method according to claim 13 characterized in that the further amylase is a maltogenic α-amylase.

15. Bakery products obtained according to claim 8 characterized in that they are free of emulsifiers on the basis of monoglycerides or contain smaller amounts of emulsifiers compared to normal bakery products.

16. A raw proofed or unproofed dough piece or pre-baked dough piece for the production of bakery products characterized in that it contains an α-amylase obtainable from Thermoactinomyces vulgaris and is free of emulsifiers on a monoglyceride basis.
